(19) United States
(12) Patent Application Publication
(10) Pub. No.: US 2006/0061986 A1
(43) Pub. Date: Mar. 23, 2006

(54) Toothbrush for bleaching teeth

(75) Inventors: Ju-Chia Kuo, Ping Chen City (TW); Ching-Sung Hsiao, Hsinchu City (TW); Ting-Wei Huang, Hsinchu City (TW)

Correspondence Address: BRUCE H. TROXELL;SUITE 1404, 5205 LEESBURG PIKE, FALLS CHURCH, VA, 22041, US

(73) Assignee: Industrial Technology Research Institute

(21) Appl. No.: 11/014,175

(22) Filed: Dec. 17, 2004

(30) Foreign Application Priority Data
Sep. 21, 2004 (TW) 93128629

(51) Int. Cl. F21V 33/00

(52) U.S. Cl. 362/109

(57) ABSTRACT

A toothbrush for bleaching teeth includes a brush face and a self-illumination device. The self-illumination device further includes a power source, a switch, and an illumination element. In the case that the switch is at a close state, the illumination element can generate a ray out through an illumination area on the brush face so as to act with a toothpaste cooperated with the toothbrush for generating a tooth-bleaching result.

### BACKGROUND OF THE INVENTION

(1) Field of the Invention

The invention relates to a toothbrush structure, and more particularly to the structure that is capable of self-illuminating for simultaneously light-treating teeth.

(2) Description of the Prior Art

Though having a shining snow-white teeth is definite a spectacular appearance to attract people's attention, yet only few people can have such an attracting feature. Due to various reasons, the color of teeth is usually neither white nor healthy ivory. In some serious cases, teeth might have terrible dark spots or cavities by which people may feel embarrassed to speak and, as the worst result, may affect their social relationship.

Reasons to cause dark spots on the teeth may be various, including cavities, color foods (such as curry food and colored candies), color drinks (such as coffee, tea, and red wines), smoking, areca nuts, and so on. Also, a medication history related to antibiotic drugs, effect of fluorides or aging may be reasons leading to a spot or bad-looking tooth.

In the art, therapies to cure the spot tooth are usually determined by the cause and degree of the problem. These therapies include a whitening treatment of adding a particular whitewash and a treatment of ceramic coating. The treatment of ceramic coating is firstly to remove a thin surface layer of the tooth at the concerned area, and then to coat or adhere a ceramic coating onto the tooth so as to cover the spot area. A major advantage of this treatment is the endurability of the ceramic coating, but on the other hand the high cost is the hard-to-accept factor.

In the art, the whitening treatments upon the teeth includes the in-home whitening, clinic whitening, and a combination of the above two. No matter what kind of the whitening treatment is used, the treating agents all include some particular chemicals such as hydrogen peroxides and/or carbamide peroxides. During the whitening treatment, the aforesaid chemicals can undergo an oxidoreductase reaction to generate free radicals for further breaking down and thus de-coloring the color molecules on the tooth. Thereby, the spot tooth can be successfully whitened.

In the previous oxidoreductase reaction, lasers, luminescent lights or luminescent gels are usually used to catalyze the whitening. Among them, the lasers and the luminescent lights can achieve more satisfied whitening results. Yet, these two methods can only be operated in a qualified clinic under a supervision of an experienced doctor.

The reason that the treatment using the lasers and the luminescent lights can only be operated in the clinic is because a higher concentration of the whitewash is involved in these treatment. Generally, a teeth mask for isolating the treatment teeth is applied. Also, improper usage of the teeth mask or ill-control upon the whitewash's concentration may cause canker sores or damages of some soft tissues in the mouth. In addition, accidental swallowing of the whitewash may also lead to possible discomfort of the digestive system.

On the other hand, the in-home whitening is to perform a low-energy oxidoreductase reaction by the user himself/herself with an individual teeth mask and a low-concentrated whitewash. The safe in-home whitening is usually catalyzed by a luminescent gel and so can achieve a substantial degree of whitening on the teeth. Yet, due to the concentration of the whitewash and the work of the luminescent means, the whitening performance of the in-home operation can never come close to that of the whitening operation in clinic which utilizes a laser or a luminescent light as the catalyzing source.

Nevertheless, either the in-home whitening or the in-clinic whitening needs a substantial treatment time that definitely affects the ordinary life.

### SUMMARY OF THE INVENTION

Accordingly, it is an object of the present invention to provide a toothbrush for bleaching teeth which can utilize a self-illumination device to help bleaching the teeth during everyday tooth-brushing. The self-illumination device is constructed inside the toothbrush and can provide an illumination face to the brush face of the toothbrush. By cooperated with a particular toothpaste, the toothbrush having the self-illumination device can provide a whitening operation comparable to the in-clinic whitening without altering the ordinary life.

The toothbrush for bleaching teeth in accordance with the present invention comprises a brush face planted with a plurality of bristles and a self-illumination device. The self-illumination device further includes a power source, a switch and an illumination element. In the case that the switch acts to have the self-illumination device posed at a close-loop state, the illumination element can generate a light at an illumination area of the brush face.

In the present invention, the light at the illumination area can be a luminescent light or other harmless light. The choice of the light is dependent upon the whitening toothpaste or the whitewash that is cooperated with the toothbrush of the present invention.

In one embodiment of the present invention, the illumination element further includes at least a luminescent diode for generating the light at the illumination area. That is to say that the illumination element of the present invention can be formed by a single illumination part, or a plurality of the illumination parts (for example, a multi-chip illumination element).

In one embodiment of the present invention, the power source of the toothbrush can include a battery set.

In one embodiment of the present invention, the power source of the toothbrush can include an external plug and an adapter.

In one embodiment of the present invention, the illumination element of the self-illumination device can be constructed at the illumination area.

In one embodiment of the present invention, the illumination element can be located under the illumination area and preferably positioned amid a concave light-reflecting surface for torching light of the illumination element to form the light at the illumination area.

In one embodiment of the present invention, the self-illumination device can include at least an optical fiber for conveying light emitted by the illumination element to the illumination area so as to form the light at the illumination area. Upon such an arrangement, one end of the optical fiber can be directly located above the illumination area, or can be located under the illumination area and positioned amid a concave light-reflecting surface for torching light of the illumination element to form the light at the illumination area.

All these objects are achieved by the toothbrush for bleaching teeth described below.

### BRIEF DESCRIPTION OF THE DRAWINGS

The present invention will now be specified with reference to its preferred embodiment illustrated in the drawings, in which:

FIG. 1 is a schematic perspective view of a preferred embodiment of the toothbrush for bleaching teeth in accordance with the present invention;

FIG. 2 is a block diagram of an embodiment of the self-illumination device of the toothbrush for bleaching teeth in accordance with the present invention;

FIG. 3 is a block diagram of another embodiment of the self-illumination device of the toothbrush for bleaching teeth in accordance with the present invention;

FIG. 4 is a schematic view of an embodiment of the brush portion of the toothbrush for bleaching teeth in accordance with the present invention;

FIG. 5 is a schematic view of another embodiment of the brush portion of the toothbrush for bleaching teeth in accordance with the present invention;

FIG. 6 is a schematic view of another embodiment of the toothbrush for bleaching teeth in accordance with the present invention;

FIG. 7 is a schematic view of a further embodiment of the toothbrush for bleaching teeth in accordance with the present invention;

FIG. 8 is a schematic view of one more embodiment of the toothbrush for bleaching teeth in accordance with the present invention; and

FIG. 9 is a schematic view of an embodiment of the power source of the toothbrush for bleaching teeth in accordance with the present invention.

### DESCRIPTION OF THE PREFERRED EMBODIMENT

The invention disclosed herein is directed to a toothbrush for bleaching teeth. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the following description, parts of the invention who serve the same purpose but have slight difference in configuration will be identically named and labeled.

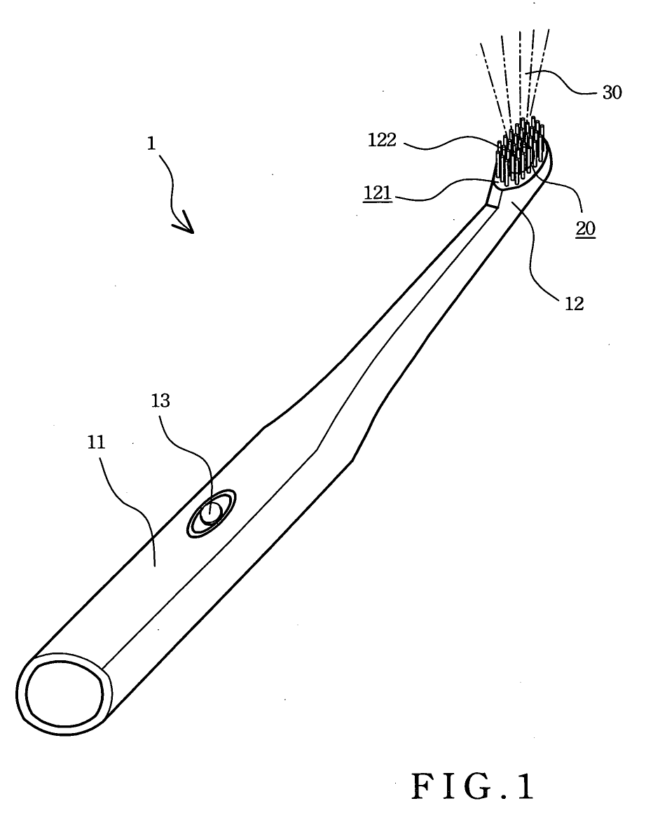

Referring now to FIG. 1, a preferred embodiment of the toothbrush in accordance with the present invention is shown in perspective. The toothbrush 1 includes a handhold portion 11 for user's handling and a brush portion 12 to be operated in user's mouth for bleaching teeth. The brush portion 12 includes a brush face 121 planted with a plurality of bristles 122. One of major characteristic of the present invention is that a self-illumination device (shown in the following figures) is mounted inside the toothbrush 1. The self-illumination device can utilize a switch 13 to present a close-loop state or an open-loop state. In the case that the switch 13 is set to have the self-illumination device posed at the close-loop state, an illumination area 20 of the brush face 121 can emit a light 30. The light 30 is called the light at the illumination area 20 in the following description. Upon such an arrangement, the light 30 at the illumination area 20 can react with a particular toothpaste or whitewash so as to make a teeth-brushing operation as a teeth-whitening treatment.

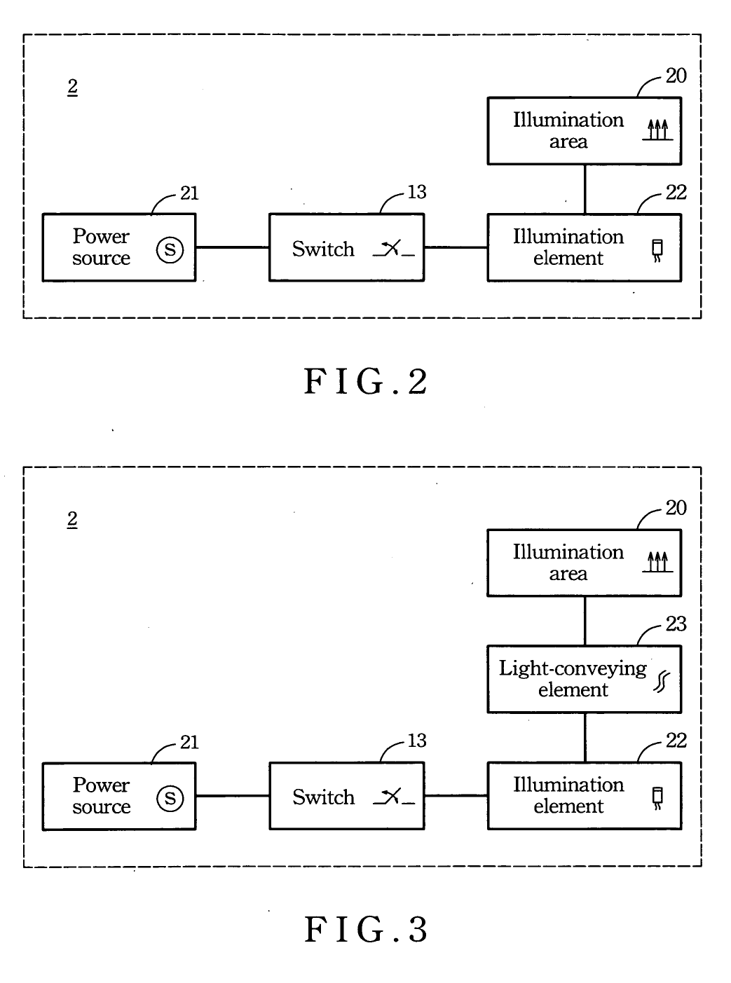

Referring now to FIG. 2, a block diagram is used to show a preferred structure of the self-illumination device 2 of the present invention. In the embodiment, the self-illumination device 2 can include a power source 21, the switch 13, an illumination element 22, and the illumination area 20 (in the brush face 121 as described above); in which the power source 21, the switch 13 and the illumination element 22 together form a loop circuitry. Between the illumination element 22 and the illumination area 20 is a light path to forward the light emitted by the illumination element 22 to the illumination area 20 so as to form the so-called light at the illumination area.

Referring now to FIG. 3, another structure of the self-illumination device 2 of the present invention is shown in a block diagram. Compared to the structure shown in FIG. 2, this embodiment of the self-illumination device 2 further includes a light-conveying element 23 located between the illumination element 22 and the illumination area 20. By providing the light-conveying element 23, the light path between the illumination element 22 and the illumination area 20 can be more flexible and thus make versatile the arrangement of the illumination element 22 inside the toothbrush.

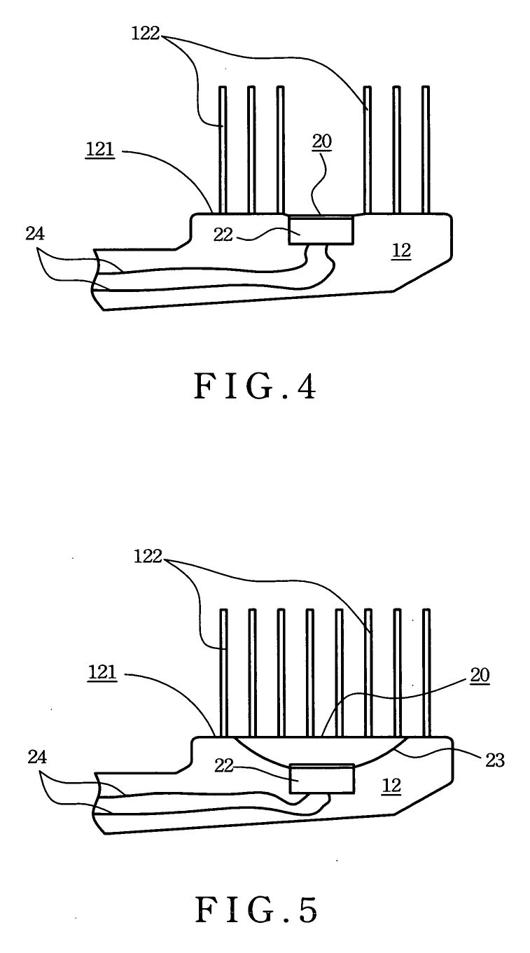

Referring now to FIG. 4, a schematic view of an embodiment of the brush portion 12 of the toothbrush for bleaching teeth in accordance with the present invention is schematically shown. As shown, the illumination element 22 of the self-illumination device is constructed at the illumination area 20. By exposing the illumination element 22 to the illumination area 20, light emitted by the illumination element 22 can be directly used as the light at the illumination area 20. Also, it is shown that the illumination element 22 is electrically connected by wires 24 to other elements of the self-illumination device (not shown in this figure).

Referring now to FIG. 5, a schematic view of another embodiment of the brush portion 12 of the toothbrush for bleaching teeth in accordance with the present invention is schematically shown. Compared to the embodiment of FIG. 4, the present illumination element 22 of the self-illumination device is located under the illumination area 20 (i.e. buried in the brush portion 12) and positioned amid a concave light-reflecting surface 23 as the light-conveying element for torching light of the illumination element 22 to form the light at the illumination area 20. Preferably, the illumination element 22 is located right at the center of the concave light-reflecting surface 23.

In the present invention, the light 30 at the illumination area 20 can be a luminescent light or other harmless light. The choice of the light is dependent upon the whitening toothpaste or the whitewash that is cooperated with the toothbrush 1 of the present invention.

In the present invention, the illumination element 22 can include a single illumination part, or a plurality of the illumination parts (for example, a multi-chip illumination element).

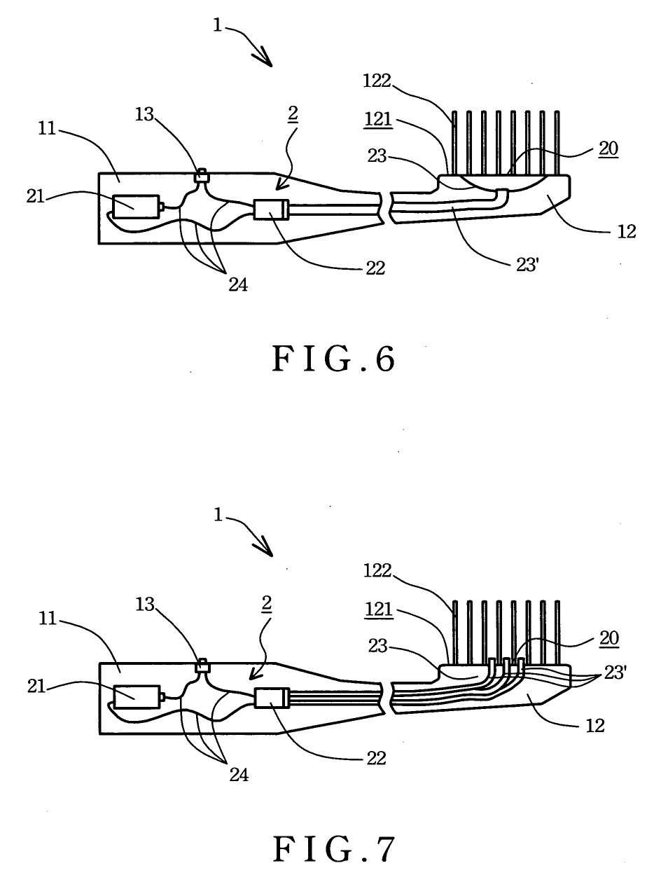

Referring now to FIG. 6, a schematic view of another embodiment of the toothbrush 1 for bleaching teeth in accordance with the present invention is schematically shown. In this embodiment, the power source 21, the switch 13 and the illumination element 22 of the self-illumination device 2 are all installed inside the handhold portion 11 of the toothbrush 1. The light path between the illumination element 22 and the illumination area 20 of the brush portion 12 is established by an optical fiber 23′ (as the first light-conveying element) and a concave light-reflecting surface 23 (as the second light-conveying element). It is noted that one end of the optical fiber 23′ is located at the center of the concave light-reflecting surface 23. Upon such an arrangement, the light emitted by the illumination element 22 at the handhold portion 11 can be conveyed to the illumination area 20 at the brush portion 12 for forming the so-called light at the illumination area 20.

Referring now to FIG. 7, a schematic view of a further embodiment of the toothbrush 1 for bleaching teeth in accordance with the present invention is schematically shown. Compared to the embodiment shown in FIG. 6, this embodiment utilizes three optical fibers 23′ to convey the light of the illumination element 22 to the illumination area 20. Three free end of these optical fibers 23′ are directly exposed above the illumination area so as to directly release the light at the illumination area 20. It is noted that, in this embodiment, the design of the concave light-reflecting surface is discarded.

In the present invention, the toothbrush 1 can be structured as a single-piece toothbrush as described above, or a two-piece auto-toothbrush.

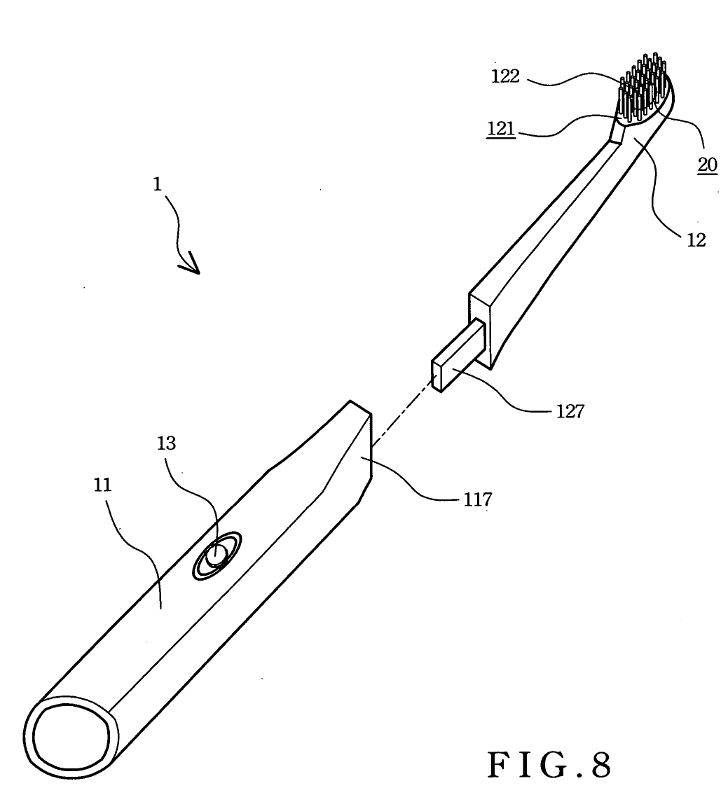

Referring now to FIG. 8, a schematic view of one more embodiment of the toothbrush 1 for bleaching teeth in accordance with the present invention is perspective shown. The toothbrush 1 constructed as a two-piece structure has a handhold portion 11 and a separate brush portion 12. The electrical, optical and structural connections in between are provided by mating an engagement socket 117 of the handhold portion 11 and a respective engagement plug 127 of the brush portion 12.

In the present invention, the power source 21 of the toothbrush 1 can be embodied as a battery set as shown FIG. 6 or FIG. 7. Yet, some other types of the power source can also be applied to the self-illumination device 2 of the present invention.

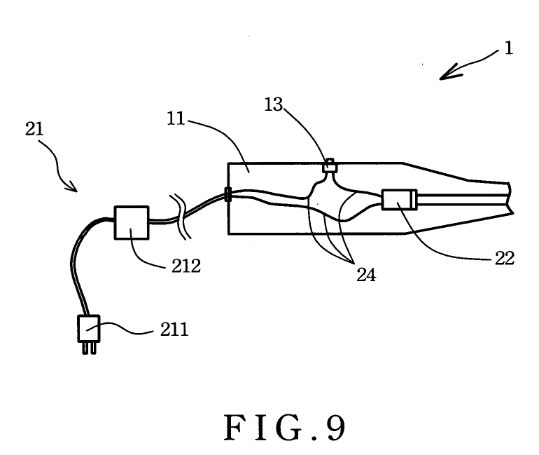

Referring now to FIG. 9, a schematic view of an embodiment of the power source 21 of the toothbrush 1 for bleaching teeth in accordance with the present invention is shown. In this embodiment, the power source 21 includes an external plug 211 and an adapter 212.

In the present invention, the electrical connections as well as the optical connections related to the battery set, the external power source, the switch, the illumination element, the wires, the optical fibers, and the other parts can be easily constructed by a skilled person in the art after understanding the teaching of the above description. Therefore, details related to such connections would be omitted herein.

By providing the toothbrush for bleaching teeth of the present invention, a preferable solution for whitening the teeth between the in-home treatment and the in-clinic treatment is successfully found. By cooperating with a relevant toothpaste or whitewash, everyday tooth-brushing with the toothbrush of the present invention can achieve benefits both in tooth bleaching and in tooth whitening comparable to the in-clinic treatment.

While the present invention has been particularly shown and described with reference to a preferred embodiment, it will be understood by those skilled in the art that various changes in form and detail may be without departing from the spirit and scope of the present invention.

I claim:

1. A toothbrush for bleaching teeth, comprising a brush face planted with a plurality of bristles, characterized in that: the toothbrush comprises a self-illumination device further having a power source, a switch and an illumination element; in the case that the switch acts to have the self-illumination device posed at a close-loop state, the illumination element generating a light at an illumination area of the brush face.

2. The toothbrush for bleaching teeth according to claim 1, wherein said illumination element further includes at least a luminescent diode for generating said light.

3. The toothbrush for bleaching teeth according to claim 1, wherein said power source includes a battery set.

4. The toothbrush for bleaching teeth according to claim 1, wherein said power source includes an external plug and an adapter.

5. The toothbrush for bleaching teeth according to claim 1, wherein said illumination element is constructed at said illumination area.

6. The toothbrush for bleaching teeth according to claim 1, wherein said illumination element is located under said illumination area and positioned amid a concave light-reflecting surface for torching light of the illumination element to form said light.

7. The toothbrush for bleaching teeth according to claim 1, further including an optical fiber to convey light of said illumination element to said illumination area so as to form said light.

8. The toothbrush for bleaching teeth according to claim 7, wherein said optical fiber has an end located above said illumination area.

9. The toothbrush for bleaching teeth according to claim 7, wherein said optical fiber has one end located under said illumination area and positioned amid a concave light-reflecting surface for torching light of the illumination element to form said light.

10. A toothbrush for bleaching teeth, comprising:
a brush face, planted with a plurality of bristles, further including an illumination area; and
a self-illumination device, for generating a light at the illumination area, further comprising:
a power source;
a switch, for determining a close-open state of the self-illumination device; and
an illumination element, constructed inside the toothbrush for emitting the light.

11. The toothbrush for bleaching teeth according to claim 10, wherein said illumination element further includes at least a luminescent diode for generating said light.

12. The toothbrush for bleaching teeth according to claim 10, wherein said power source is a battery set located inside said tooth brush.

13. The toothbrush for bleaching teeth according to claim 10, wherein said power source includes an external plug and an adapter.

14. The toothbrush for bleaching teeth according to claim 10, wherein said illumination element is constructed at said illumination area.

15. The toothbrush for bleaching teeth according to claim 10, further including a light-conveying element located between said illumination element and said illumination area for conveying light of said illumination element to said illumination area so as to form said light.

16. The toothbrush for bleaching teeth according to claim 15, wherein said light-conveying element is a concave light-reflecting surface located under said illumination area and said illumination element is positioned amid the concave light-reflecting surface.

17. The toothbrush for bleaching teeth according to claim 15, wherein said light-conveying element is an optical fiber having an end located above said illumination area.

18. The toothbrush for bleaching teeth according to claim 15, wherein said light-conveying element includes a concave light-reflecting surface located under said illumination area and an optical fiber having one end located amid the concave light-reflecting surface.
